(19) United States
(12) Patent Application Publication
(10) Pub. No.: US 2013/0281561 A1
(43) Pub. Date: Oct. 24, 2013

(54) POLYMETHACRYLIMIDE FOAMS HAVING A REDUCED RESIDUAL MONOMER CONTENT, AND PRODUCTION METHOD

(71) Applicants: Kay Bernhard, Darmstadt (DE); Mathias Hempler, Freigericht (DE); Stefan Plass, Darmstadt (DE); Werner Geyer, Brensbach (DE); Thomas Barthel, Heppenheim (DE)

(72) Inventors: Kay Bernhard, Darmstadt (DE); Mathias Hempler, Freigericht (DE); Stefan Plass, Darmstadt (DE); Werner Geyer, Brensbach (DE); Thomas Barthel, Heppenheim (DE)

(73) Assignee: Evonik Roehm GmbH, Darmstadt (DE)

(21) Appl. No.: 13/996,552

(22) PCT Filed: Dec. 13, 2011
(86) PCT No.: PCT/EP2011/072540

§ 371 Date: Jun. 21, 2013

(30) Foreign Application Priority Data
Jan. 20, 2011 (DE) 10 2011 002 905.2

(51) Int. Cl. C08J 9/04

(52) U.S. Cl. CPC C08J 9/04
USPC 521/149

(57) ABSTRACT

The invention relates to a process for producing poly(meth)acrylimide foams and also blocks, sheets and the like composed of such poly(meth)acrylimide foams and also the intermediate articles formed from the copolymer of (meth)acrylic acid and (meth)acrylonitrile, which are all distinguished by a particularly low residual monomer content.

The invention relates to a process for producing poly(meth)acrylimide foams and also blocks, sheets and the like composed of such poly(meth)acrylimide foams and also the intermediate articles formed from the copolymer of (meth)acrylic acid and (meth)acrylonitrile, which are all distinguished by a particularly low residual monomer content.

### PRIOR ART

It is known to produce poly(meth)acrylimide foams in the form of blocks. The first step is to copolymerise (meth)acrylic acid and (meth)acrylonitrile with each other to form a precursor that already has a corresponding sheet form. The copolymer is then cyclised to form the imide. A blowing agent in the reaction mixture ensures that the corresponding foam is formed on heating.

The formulation (meth)acrylimide herein describes both methacrylimides and acrylimides. The same is true mutatis mutandis of the term (meth)acrylic acid, which comprehends both acrylic acid and methacrylic acid.

However, existing processes all have the disadvantage that either large amounts of residual monomer remain in the product during synthesis, or a great deal of effort, expense and inconvenience has to be invested to reduce the residual monomer content.

The residual monomer content plays a decisive part when the poisonous acrylonitrile is used in particular.

It is further a frequent issue with prior art processes to produce polymer sheets up to 30 mm in thickness directly. Since a safe and uniform polymerisation process is an absolute requirement, the polymerisation system has to be alternatingly cooled and heated, particularly because any overheating means that the polymerisation is no longer controllable and nonuniform structures are formed. These alternating cooling and heating phases are of course inconvenient and have high energy and water requirements.

DE 1 817 156 already describes a process whereby foamable plastics are produced in sheet form by polymerising mixtures of methacrylonitrile and methacrylic acid between two glass plates separated by a flexible-cord gasket. The starting mixture already includes a blowing agent, viz. formamide or monoalkylformamide. Also included are free-radical formers, for example in the form of two-component mixture of tert-butyl perpivalate and benzoyl peroxide.

The polymerisation takes place at temperatures of 40, 45 or 48° C., for example, in the course of about 15 to 40 hours. This is followed by tempering at about 100° C. and then heating to 170-300° C. At the latter temperatures, the cyclisation to imide and foaming take place.

It is difficult to make the polymerisation uniform, since the temperature can very easily exceed the target temperature. Temperature fluctuations must therefore be policed very accurately and compensated by alternating cooling or heating phases.

EP 0 356 714 A1 describes a similar process. Azobisiso-butyronitrile for example is used as free-radical former and 0.1-10% by weight of electrically conductive particles is added to the mixture to be polymerised. The abovementioned problems also present in this process.

EP 1 175 458 describes the production of thick blocks in an isothermal process. This is achieved by using at least 4 different initiators. However, this reference is limited to methacrylonitrile and not applicable to acrylonitrile as a building block. Nor is reducing the residual monomer content addressed. Of the initiators described, the one which is active at the highest temperature has a half-life of 1 h at 115° C. to 125° C. and is effective at the tempering stage in particular and not at the foaming stage.

Foams based on methacrylic acid and acrylonitrile are described in CN 100420702C for example. These PI foams have a severely elevated level of unconverted residual monomers amounting to distinctly above 10 000 ppm of acrylonitrile.

DE 2 804 533 describes the tempering of acrylonitrile-methyl methacrylate (MMA) polymers having an acrylonitrile content of 60% to 80% by weight at not less than 130° C. with an initiator. This only results in an inefficient lowering of the residual monomer content. Heating alone does not lead to sufficiently low residual monomer contents in respect of acrylonitrile in particular. Alternatively, at least 2 initiators that decompose at high temperatures and have a 1 h half-life at 60° C. to 100° C. and at 100° C. to 140° C., respectively, can be used in addition.

However, this process is not immediately transferable to foaming and/or acid-containing systems.

### Problem

The problem addressed by the present invention was that of providing poly(meth)acrylimide foams having particularly low residual monomer contents and a toxicologically unconcerning utility, and/or a process for producing such P(M)I foams.

The problem addressed by the present invention was more particularly that of providing a process whereby polyacrylimide foams (PI foams) of particularly low acrylonitrile content are obtainable.

The problem addressed by the present invention was further that of ensuring that the P(M)I foams thus obtained are of high quality comparable to the prior art, particularly with regard to the sheet and/or block thickness obtainable, and have a uniform distribution of closed cells.

### Solution

These problems are solved by a process for producing poly(meth)acrylimide foams in block or sheet form by copolymerisation of (meth)acrylic acid and (meth)acrylonitrile with or without further copolymerisable monomers in the three process steps of polymerisation, tempering and foaming at three respectively higher process temperatures relative to the preceding process step, in the presence of free-radical initiators.

Secondary polymerisation takes place in the process step of tempering. These developments continue concurrently during the third process step of conversion into a foam and cyclisation of the copolymer to the polyimide.

Preferably, the polymerisation is carried out at a temperature between 30 and 80° C., the tempering is carried out at least partially at a temperature between 80 and 120° C., and the foaming is carried out at a temperature between 120 and 200° C. The tempering is generally carried out at a temperature rising monotonously or in stages, with at least the final temperature being between 80 and 120° C.

The process according to the invention is more particularly characterized in that the polymerisation mixture contains at least three initiators. It is more particularly important in this connection that the decomposition temperatures of the three initiators are such that the first initiator has a one hour half-life below 80° C., preferably in a range from 40 to 80° C. and more preferably in a range from 50 to 75° C., the second initiator has a one hour half-life between 80 and 120° C., preferably in a range of 85 to 100° C., and the third initiator has a one hour half-life above 120° C., preferably in a range of 120 to 180° C. and more preferably in a range of 120 to 150° C. This results in a product being obtained directly after foaming that has a (meth)acrylonitrile content below 6000 ppm and more particularly below 1000 ppm.

It is particularly preferable for the decomposition temperatures of the three initiators to be at least 10° C. and preferably at least 15° C. apart.

It is particularly preferable for the mixture to be composed of three initiators as follows, based on the entire composition: 0.5% to 1.5% by weight of a first initiator having a one hour half-life in the range from 50 to 75° C.,

0.01% to 0.2% by weight of a second initiator having a one hour half-life in the range from 85 to 100° C. and 0.01% to 0.2% by weight of a third initiator having a one hour half-life in the range from 120 to 150° C.

It is likewise preferable for the monomer composition and the poly(meth)acrylimide foam obtained therefrom to additionally contain 8% to 18% by weight of dimethyl propylphosphonate as fire protection stabiliser.

The present invention provides more particularly two preferred embodiments:

A first embodiment is characterized in that exactly three initiators are used. This concerns more particularly an embodiment wherein polymethacrylimide foams (PMI foams) are obtained from a mixture of methacrylic acid and methacrylonitrile.

In the second particular and preferred embodiment, polyacrylimide foams are obtained by copolymerising a mixture of methacrylic acid and acrylonitrile with or without further copolymerisable monomers. It is particularly preferable for this embodiment to utilise at least four, preferably four or five, initiators for respectively different temperature ranges. The fourth and optionally fifth initiators can each have a decomposition temperature in the range of one of the four initiators described above and be activated therewith in respectively the same process step.

Alternatively, the four initiators used can have one hour half-lives in the ranges from 50 to 75° C., from 85 to 100° C., from 120 to 130° C. and from 130° C. to 180° C. Preferably, these temperatures of the four initiators are at least 15° C. apart.

Preferably, this mixture of four initiators is composed, based on the entire composition, of 0.5% to 1.5% by weight of a first initiator having a one hour half-life in the range from 50 to 75° C., 0.01% to 0.2% by weight of a second initiator having a one hour half-life in the range from 85 to 100° C. and 0.01% to 0.2% by weight of a third initiator having a one hour half-life in the range from 120 to 130° C. and 0.01% to 0.2% by weight of a fourth initiator having a one hour half-life in the range from 130 to 180° C.

The amount of initiator mixture used can be varied within relatively wide limits; the polymerisation time can be controlled thereby, and the polymerisation temperature can also be influenced via the amount of initiators used. The amount statements used in the context of the invention are stated in parts by weight of initiator per 100 parts by weight of monomer.

The first step in producing foams in block form is the production of monomer mixtures containing (meth)acrylic acid and (meth)acrylonitrile, preferably in a molar ratio between 2:3 and 3:2 as main constituents. Further comonomers can be used in addition, for example esters of acrylic or methacrylic acid, styrene, maleic acid or itaconic acid, and/or anhydrides thereof, or vinylpyrrolidone. The proportion of comonomers should not amount to more than 30% by weight and preferably not more than 10% by weight of the two main constituents. Small amounts of crosslinking monomers, such as allyl acrylate for example, can be used. However, the amounts should preferably be at most 0.05% to 2.0% by weight.

The mixture for the copolymerisation further contains blowing agents which either decompose or vaporise at temperatures of about 150 to 250° C., forming a gas phase in the process. Examples of suitable blowing agents are the nitrogenous compounds urea, monomethylurea or N,N′-dimethylurea, formamide or monomethylformamide. Further, nitrogen-free blowing agents are formic acid, water or monohydric aliphatic alcohols particularly those of three to eight carbon atoms. The blowing agents are generally used in amounts of 0.5% to 8% by weight based on the monomers used.

The polymerisation conveniently takes place in block form. To produce flat ones, for example in layers having thicknesses up to 80 mm, the monomer mixture is positioned between two glass plates which are sealed at each edge to form a kind of flat chamber. This flat chamber is surrounded by a water bath which is set to the desired polymerisation temperature.

The polymerisation can largely or extensively be carried out under isothermal conditions, i.e. at constant water bath temperature. In many cases, the water bath temperature can be kept constant from the start to the end of the polymerisation. Optionally, however, the water bath temperature can also be initially kept constant for a long period and raised after a particular period in order to perform part of the polymerisation at a higher temperature.

In this next polymerisation phase too, which is performed at a higher temperature, the water bath temperature can be kept constant.

The choice of water bath temperature depends on the thickness of the polymerisation chamber and on the recipe used in the polymerisation. It is generally advantageous in this connection to shift the polymerisation temperature and hence also the temperature of the water bath to lower values with increasing thickness for the sheet to be produced.

The suitable temperature for the recipe and the thickness can in each case be optimised by simple preliminary tests.

It will be readily understood that the temperature is adjusted to the thickness of the chamber and of the recipe within the above-recited limits such that the heat released in the course of the polymerisation can be adequately removed without undesired temperatures in the polymerisation mixture occurring during the polymerisation. On completion of the polymerisation process which is controlled by the surrounding water bath, the tempering is carried out in a thermal cabinet. The tempering generally takes place at temperatures of 80 to 120° C. and, as already mentioned, can be conducted with a uniformly or incrementally rising temperature profile starting at 38° C. and preferably starting at the polymerisation temperature. This end-stage polymerisation in the tempering cabinet generally takes from 10 to 1000 hours.

On completion of the polymerisation, the block is heated to a temperature of about 120 to 250° C. and preferably in the range from 120 to 200° C., at which temperature the cyclisation to the imide structure and the foaming take place.

It is generally sufficient to allocate times from 3 to 5 hours for this thermal aftertreatment. For instance, the imidisation may be complete within one hour and the foaming within two further hours. The blocks obtained are marked by a homogeneous uniform structure.

These sheets of polymer are formed as an intermediate product in the production of the block-shaped (meth)acrylimide foams according to the invention. The invention further provides sheets of polymer which are obtainable by the process indicated above.

The process according to the invention provides an isothermal polymerisation, i.e. a polymerisation at constant temperature, producing blocks of polymer which are up to 80 mm in thickness and which have a unitary property profile throughout the entire thickness of the block, which is a hallmark of a uniform homogeneous polymerisation. The blocks of foam which are produced therefrom can be end itemed as such, in which case only very little scrap is generated at the edge regions. It is thereby possible to use just a single block to produce shaped articles of corresponding thickness which used to require several blocks adhered together. The one-piece foamed blocks/sheets obtained are preferably from 80 to 300 mm in thickness.

It is a special aspect of the present invention that initiators from various temperature ranges are used such that they are activated in the various process steps and thus lead to specifically set initiator concentrations in all process steps. This process provides a surprising combination of various technical effects. First, foam materials having a very uniform and efficiently adjustable foam structure are obtained. Secondly, the residual monomer contents are reduced in a particularly efficient way. This applies particularly to the critical methacrylonitrile and to the even more critical acrylonitrile. Thirdly, it was very surprising that the good results are transferable to acrylimide foams and the technical effects also manifest in the production of polyacrylimide (PI) foams.

Suitable initiators for use according to the invention in a mixture comprising at least three initiators can be conventional initiators as used for free-radical formation in free-radically initiated polymerisations. They include compounds such as organic peroxides, such as dicumyl peroxide, peroxydicarbonates such as diisopropyl peroxydicarbonate, peresters such as tert-butyl peroxy-2-ethylhexanoate and comparables. Other types of compound which are capable of forming free radicals are also suitable in the context of the invention. They include more particularly azo compounds such as azobis(isobutyronitrile) and azobis(2,4-dimethylvaleronitrile).

Initiator mixtures which are particularly suitable in the context of the invention have their components selected from the following initiators: azobis(isobutyronitrile), t-butyl peroctoate, t-butyl per-2-ethylhexanoate, t-butyl perbenzoate, t-butyl perpivalate, azobis(2,4-dimethylvaleronitrile), t-butyl perneodecanoate, di-t-butyl peroxide, dibenzoyl peroxide, bis(4-t-butylcyclohexyl) peroxidicarbonate, cumyl peroxineodecanoate and 1,4-di-(2-neodecanoylperoxyisopropyl)benzene.

The half-life of usable initiators is generally already reported by the manufacturing company. It can be easily determined analytically, in which case benzene will generally prove to be suitable as solvent. The determination is generally done using a 0.1 molar solution.

Similarly, foamed blocks or sheets, or equivalently foam sheets and foam blocks, respectively, which were obtained according to the process of the invention form part of the subject-matter of the present invention. This concerns not only the process but also the products obtained therefrom for producing poly(meth)acrylimide foams.

These foam sheets and foam blocks are very useful materials of construction and can be used more particularly as structural components in the building of flight vehicles, vehicles, track vehicles, spacecraft, aircraft or in shipbuilding. The blocks of polymer which are produced according to the invention are notable for a very uniform structure and a very low residual monomer content. They can be stored for as long as desired and periodically converted when desired into foam sheets by appropriate heating.

The invention is more particularly elucidated using ensuing examples:

### EXAMPLES

### Comparative Example 1

A mixture of 57 parts of methacrylic acid and 43 parts of acrylonitrile was admixed with 4.2 parts of isopropanol and 4.7 parts of formamide as blowing agents. The mixture was further admixed with 0.103 part of cumyl perneodecanoate, 0.04 part of tert-butyl perpivalate, 0.04 part of tert-butyl per-2-ethylhexanoate, 50 ppm of p-benzoquinone, 0.22 part of zinc oxide and 0.150 part of release agent (PAT 1037).

This mixture was polymerised in melt-sealed glass ampoules at 40° C. for 94 h. The polymer was subsequently end-polymerised by subjecting it to a tempering programme ranging from 32° C. to 100° C. for 32 h. In the course of this tempering programme, the temperature increases linearly from the lower to the upper temperature limit within the stated period.

The subsequent foaming in the hot-air process took place at 185° C. for 2 h. The foam thus obtained had an envelope density of 27 kg/m³. The residual level of unconverted methacrylic acid was determined as 2586 ppm and of unconverted acrylonitrile as 9810 ppm.

This comparative example was not in accordance with the invention in using three initiators having one hour half-life decomposition temperatures below 100° C. The high residual acrylonitrile content shows that such a process is unsuitable for solving the problems addressed by this invention.

### Inventive Example 1:

A mixture of 57 parts of methacrylic acid and 43 parts of acrylonitrile was admixed with 4.2 parts of isopropanol and 4.7 parts of formamide as blowing agents. The mixture was further admixed with 0.103 part of cumyl perneodecanoate, 0.04 part of tert-butyl perpivalate, 0.04 part of tert-butyl per-2-ethylhexanoate, 0.07 part of tert-butyl perbenzoate, 50 ppm of p-benzoquinone, 0.22 part of zinc oxide and 0.150 part of release agent (PAT 1037). This mixture was polymerised in melt-sealed glass ampoules at 40° C. for 94 h. The polymer was subsequently end-polymerised by subjecting it to a tempering programme ranging from 32° C. to 100° C. for 32 h. In the course of this tempering programme, the temperature increases linearly from the lower to the upper temperature limit within the stated period.

The subsequent foaming in the hot-air process took place at 185° C. for 2 h. The foam thus obtained had an envelope density of 70 kg/m³. The residual level of unconverted methacrylic acid was determined as 202 ppm and of unconverted acrylonitrile as 5850 ppm.

### Inventive Example 2:

A mixture of 57 parts of methacrylic acid and 43 parts of acrylonitrile was admixed with 4.2 parts of isopropanol and 4.7 parts of formamide as blowing agents. The mixture was further admixed with 0.103 part of cumyl perneodecanoate, 0.04 part of tert-butyl perpivalate, 0.04 part of tert-butyl per-2-ethylhexanoate, 0.07 part of tert-butyl perbenzoate, 0.1 part of di-tert-butyl peroxide, 50 ppm of p-benzoquinone, 0.22 part of zinc oxide and 0.150 part of release agent (PAT 1037).

This mixture was polymerised in melt-sealed glass ampoules at 40° C. for 94 h. The polymer was subsequently end-polymerised by subjecting it to a tempering programme ranging from 32° C. to 100° C. for 32 h. In the course of this tempering programme, the temperature increases linearly from the lower to the upper temperature limit within the stated period.

The subsequent foaming in the hot-air process took place at 185° C. for 2 h. The foam thus obtained had an envelope density of 73 kg/m³. The residual level of unconverted methacrylic acid was determined as 82 ppm and of unconverted acrylonitrile as 4660 ppm.

### Inventive Example 3:

A mixture of 57 parts of methacrylic acid and 43 parts of methacrylonitrile was admixed with 4.2 parts of isopropanol and 4.7 parts of formamide as blowing agents. The mixture was further admixed with 0.103 part of cumyl perneodecanoate, 0.04 part of tert-butyl perpivalate, 0.04 part of tert-butyl per-2-ethylhexanoate, 50 ppm of p-benzoquinone, 0.22 part of zinc oxide and 0.150 part of release agent (PAT 1037).

This mixture was polymerised in melt-sealed glass ampoules at 50° C. for 19.75 h. The polymer was subsequently end-polymerised by subjecting it to a tempering programme ranging from 32° C. to 115° C. for 32 h. In the course of this tempering programme, the temperature increases linearly from the lower to the upper temperature limit within the stated period.

The subsequent foaming in the hot-air process took place at 185° C. for 2 h. The foam thus obtained had an envelope density of 55 kg/m³. The residual level of unconverted methacrylic acid was determined as 5137 ppm and of unconverted methacrylonitrile as 1660 ppm.

1. A process for producing a poly(meth)acrylimide foam in block or sheet form, the process comprising copolymerizing (meth)acrylic acid and (meth)acrylonitrile with or without further copolymerisable monomers in three process steps of polymerisation; and
tempering and foaming at three respectively higher process temperatures, wherein a polymerisation mixture contains three initiators, in which decomposition temperatures of the three initiators are such that the first initiator has a one hour half-life below 80° C., the second initiator has a one hour half-life between 80 and 110° C. and the third initiator has a one hour half-life above 110° C., and a product directly after foaming has a (meth)acrylonitrile content below 6000 ppm.

2. The process according to claim 1, wherein the polymerisation is carried out at a temperature between 30 and 80° C., the tempering is carried out at least partially at a temperature between 80 and 110° C., and the foaming is carried out at a temperature between 110 and 200° C.

3. The process according to claim 1, wherein the first initiator has a one hour half-life of from 40 to 80° C., the second initiator has a one hour half-life of from 80 to 110° C. and the third initiator has a one-hour half-life of from 110 to 180° C., and the decomposition temperatures of the three initiators are at least 10° C. apart.

4. The process according to claim 3, wherein the first initiator has a one hour half-life of from 50 to 75° C., the second initiator has a one hour half-life of from 85 to 100° C. and the third initiator has a one hour half-life of from 110 to 150° C., and the decomposition temperatures of the three initiators are at least 15° C. apart.

5. The process according to claim 1, wherein the product directly after foaming has a (meth)acrylonitrile content below 1000 ppm.

6. The process according to claim 1, wherein the mixture of three initiators comprises based on the entire composition, of from 0.5% to 1.5% by weight of a first initiator having a one hour half-life of from 50 to 75° C., of from 0.01% to 0.2% by weight of a second initiator having a one hour half-life of from 85 to 100° C. and of from 0.01% to 0.2% by weight of a third initiator having a one hour half-life of from 110 to 150° C.

7. The process according to claim 1, wherein the poly(meth)acrylimide foam further comprises of from 8% to 18% by weight of dimethyl propylphosphonate.

8. The process according to claim 1, wherein the polymerisation mixture comprises exactly three initiators.

9. The process according to claim 1, comprising copolymerising a mixture of methacrylic acid and acrylonitrile with or without further copolymerisable monomers.

10. The process according to claim 9, wherein the polymerisation mixture comprises at least four initiators for respectively different temperature ranges.

11. The process according to claim 10, wherein the first initiator has a one hour half-life of from 50 to 75° C., the second initiator has a one hour half-life of from 85 to 100° C., the third initiator has a one hour half-life of from 110 to 130° C. and the fourth initiator has a one hour half-life of from 130 to 180° C., and the decomposition temperatures of the four initiators are at least 15° C. apart.

12. The process according to claim 11, a mixture of four initiators comprises, based on the entire composition, of from 0.5% to 1.5% by weight of a first initiator having a one hour half-life of from 50 to 75° C., of from 0.01% to 0.2% by weight of a second initiator having a one hour half-life of from 85 to 100° C. [[and]] of from 0.01% to 0.2% by weight of a third initiator having a one hour half-life of from 110 to 130° C. and of from 0.01% to 0.2% by weight of a fourth initiator having a one hour half-life from 130 to 180° C.

13. A foamed block or sheet of polymethacrylimide obtained by a process according to claim 1.

14. A formed block or sheet of polyacrylimide obtained by a process according to claim 1.

15. The foamed block or sheet according to claim 13, wherein the foamed block or sheet is suitable for a structural component in building of flight vehicles, vehicles, track vehicles, spacecraft, aircraft or in shipbuilding.
